(19) United States
(12) Patent Application Publication
(10) Pub. No.: US 2012/0032972 A1
(43) Pub. Date: Feb. 9, 2012

(54) MOBILE TERMINAL PROVIDING LIGHTING AND HIGHLIGHTING FUNCTIONS AND CONTROL METHOD THEREOF

(76) Inventor: Byunghee HWANG, Hwaseong (KR)

(21) Appl. No.: 13/018,160

(22) Filed: Jan. 31, 2011

(30) Foreign Application Priority Data
Aug. 6, 2010 (KR) 10-2010-0076053

(51) Int. Cl. G09G 5/02; G06F 3/041

(52) U.S. Cl. 345/592; 345/589; 345/173

(57) ABSTRACT

A mobile terminal of an embodiment including a first display unit having a light-transmissive light emitting element and a second display unit overlaid on the first display unit, and a corresponding control method, the method including: displaying contents on the second display unit; and controlling display characteristics of a first area of the first display unit. In controlling the display characteristics, the display characteristics of a light emitting element included in the first area are changed for the contents displayed on the second display unit.

### CROSS REFERENCE TO RELATED APPLICATIONS

The present application claims priority to Korean Application No. 10-2010-0076053 filed in Korea on Aug. 6, 2010, the entire contents of which is hereby incorporated by reference in its entirety.

### BACKGROUND OF THE INVENTION

1. Field of the Invention

This document relates to controlling lighting and highlighting functions of a mobile terminal.

2. Description of the Related Art

In general, terminals may be divided into a mobile terminal and stationary terminal according to whether or not terminals are portable. In addition, mobile terminals may be divided into a handheld terminal and a vehicle mount terminal according to whether or not users can directly carry it around.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device. Efforts are ongoing to support and increase the functionality of mobile terminals. Such efforts include software and hardware improvements, as well as changes and improvements in the structural components which form the mobile terminal.

In general, a mobile terminal uses an LCD as a display unit, and recently, an OLED (Organic Light-Emitting Diode), and the like, is also used as the display unit of the mobile terminal. Recently, as the functions of terminals are diversified, demand for development of a convenience user interface (UI) having good visibility is increasing.

### SUMMARY OF THE INVENTION

Accordingly, one object of the present invention is to provide a mobile terminal capable of providing lighting and highlighting functions to a display unit overlaid on a transparent display unit by using the transparent display unit and providing user interfaces by using the same.

To achieve the above objects, there is provided a method for controlling a mobile terminal comprising a first display unit configured to comprise a light-transmissive light emitting element and a second display unit overlaid on the first display unit.

The method may comprise: displaying contents on the second display unit; and controlling display characteristics of a first area of the first display unit, wherein, in controlling the display characteristics, the display characteristics of a light emitting element included in the first area are changed for the contents displayed on the second display unit.

The first area may be the entire area or a particular area of the first display unit.

The display characteristics of the light emitting element may be characteristics related to the transparency, the brightness, or the color of the light emitting element.

In changing the display characteristics of the light emitting element, the display characteristics may be controlled such that the transparency is maintained although the intensity of light emission (or illumination) increases or the color of radiated light is changed.

The method may further comprise: determining whether or not to control the display characteristics of the first area.

Whether to change the display characteristics may be determined by using a user input, time information, or illumination information outside of the mobile terminal.

The mobile terminal may include a touch sensor unit integrated with the first display unit, and the method may further include: receiving a signal for selecting the first area through the touch sensor unit.

In selecting the first area, the first area on the display unit may be bounded (namely, a boundary line of the first area is set on the display unit) and the interior of the first area may be selected.

In setting the boundary line of the first area, the boundary line may be demarcated along a closed loop, starting from a portion of the first display unit to which a touch input is provided as a start point, the contour of the boundary line being determined along a path to which a drag input is provided, and ending at the start point when the touch input is stopped at the start point or at a portion near the start point.

The method may further include: receiving a signal for designating a reference point corresponding to a particular pixel within the selected first area; receiving a signal for shifting the designated reference point such that the designated reference point corresponds to a different pixel on the first display unit; and resetting the boundary line of the first area on the basis of the shifted reference point, wherein the reset boundary line of the first area has the same shape as that before the shifting.

The signal for designating the reference point may be a touch input inputted through the touch sensor unit, and the signal for shifting the reference point may be a drag input inputted through the touch sensor unit.

The mobile terminal may further include a camera, and the signal for shifting the reference point may be inputted according to a motion recognition function on the basis of a motion of a face and/or a motion of an eye inputted through the camera.

To achieve the above objects, there is also provided a method for controlling a mobile terminal comprising a first display unit configured to comprise a light-transmissive light emitting element, a second display unit overlaid on the first display unit, and a touch sensor unit integrated with the first display unit.

The method may include: displaying contents on the second display unit; receiving a signal for selecting a first area of the first display unit through the touch sensor unit, the first area corresponding to a portion of the second display unit on which particular contents is displayed or corresponding to the vicinity; and controlling display characteristics of the selected first area, wherein the controlling of the display characteristics is changing the display characteristics of a light emitting element included in the selected first area.

The display characteristics of the light emitting element may be characteristics related to transparency, brightness, or color of the light emitting element.

The method may further include: storing the particular contents in a repository.

The first area may correspond to the interior of a boundary line of the portion on which the particular contents is displayed or a portion including the vicinity, and the particular contents determining the boundary line may be contents displayed on the second display unit including the interior of a closed loop, starting from a portion of the first display unit to which a touch input is provided as a start point, the contour of the boundary line being determined along a path to which a drag input is provided, and ending at the start point when the touch input is stopped at the start point or at a portion near the start point.

The first area may correspond to an underline of the particular contents, and the particular contents determining the underline may be contents displayed on the second display unit corresponding to a line, starting from a portion of the first display unit to which a touch input is provided as a start point, the line of the boundary line being determined along a path to which a drag input is provided, and ending at a point at which the touch point is stopped as an end point.

To achieve the above objects, there is also provided a mobile terminal including: a first display unit configured to comprise a light-transmissive light emitting element; a second display unit overlaid on the first display unit; and a controller configured to display contents on the second display unit and control display characteristics of a first area of the display unit.

The first area may be the entire area or a particular area of the first display unit, the controlling of the display characteristics may be performed by changing the display characteristics of a light emitting element included in the first area for the contents displayed on the second display unit, the display characteristics of the light emitting element may be characteristics related to transparency, brightness, or color of the light emitting element, and in changing the display characteristics of the light emitting element, the display characteristics may be controlled such that the transparency is maintained although the intensity of light emission (or illumination) increases or the color of radiated light is changed.

To achieve the above objects, there is also provided a mobile terminal including: a first display unit configured to comprise a light-transmissive light emitting element; a second display unit overlaid on the first display unit; a touch sensor unit integrated with the first display unit, a controller configured to display contents on the second display unit, receive a signal for selecting a first area of the first display unit through the touch sensor unit, and control display characteristics of the selected first area, the first area corresponding to a portion of the second display unit on which particular contents is displayed or corresponding to the vicinity, and the controlling of the display characteristics being changing the display characteristics of a light emitting element included in the selected first area; and a repository configured to store the particular contents.

According to an method for controlling a mobile terminal in this document, when the user of a terminal reads contents displayed on the display unit which does not have a light emission function such as electronic-paper, or the like, in an environment in which an external illumination around the terminal is poor, the lighting function of the transparent display unit overlaid on the display unit can be used, to allow the user to reads the contents. Thus, the lighting function in this document can be manually started according to a user input or the lighting function may be controlled to be automatically controlled in consideration of visual information of the size of the external illumination, providing user convenience.

In addition, according to an method for controlling a mobile terminal in this document, a portion of the transparent display unit can be selectively controlled to provide a lighting function by limiting a particular application or a screen area requiring the lighting function, the amount of unnecessarily consumed power can be controlled.

Also, according to an method for controlling a mobile terminal in this document, because a highlighting function is provided by controlling the display characteristics of the transparent display unit with respect to a portion of contents displayed on the display unit such as electronic-paper, or the like, a user may be provided with a user experience as if he views a highlighted particular portion of contents printed on general paper. In addition, because a function of storing a particular portion is provided, a user experience similar to utilization of contents through copying and pasting in a general computing environment.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a schematic block diagram of a mobile terminal according to an exemplary embodiment of the present invention;

FIG. 2A is a front perspective view of the mobile terminal according to an exemplary embodiment of the present invention;

FIG. 2B is a rear perspective view of the mobile terminal illustrated in FIG. 2A;

FIG. 3 is a view for explaining the principle of electronic-paper applied to an exemplary embodiment of the present invention;

FIG. 4A to FIG. 4C are sectional views of a dual-display units for explaining the driving of the dual-display units with respect to a touch input in the mobile terminal having the dual-display units according to an exemplary embodiment of the present invention;

FIG. 5A and FIG. 5B are sectional views of the dual-display units illustrating the driving of the dual-display units controlling display characteristics in the mobile terminal having the dual-display units, and FIG. 5C is a view of a exemplary structure of a light emitting element;

FIG. 6 is a flow chart illustrating the process of a method for controlling a mobile terminal including a display unit configured to include a light-transmissive light emitting element according to a first exemplary embodiment of the present invention;

FIG. 7A to FIG. 7E illustrate application examples of a method for controlling the display characteristics of a particular area of the display unit configured to include the light-transmissive light emitting element according to a first exemplary embodiment of the present invention;

FIG. 8 is a flow chart illustrating the process of a method for controlling a mobile terminal including a display unit configured to include a light-transmissive light emitting element according to a second exemplary embodiment of the present invention;

FIG. 9A to FIG. 9D illustrate application examples of a method for controlling the display characteristics of a particular area of the display unit configured to include the light-transmissive light emitting element according to the second exemplary embodiment of the present invention;

FIG. 10 is a flow chart illustrating the process of a method for controlling a mobile terminal including a display unit configured to include a light-transmissive light emitting element according to a third exemplary embodiment of the present invention; and

FIG. 11A to FIG. 11D illustrate application examples of a method for controlling the display characteristics of a particular area of the display unit configured to include the light-transmissive light emitting element according to the third exemplary embodiment of the present invention.

### DETAILED DESCRIPTION OF THE INVENTION

The mobile terminal according to exemplary embodiments of this document will now be described with reference to the accompanying drawings. In the following description, usage of suffixes such as ‘module’, ‘part’ or ‘unit’ used for referring to elements is given merely to facilitate explanation of this document, without having any significant meaning by itself.

The mobile terminal described in this document may include mobile phones, smart phones, notebook computers, digital broadcast receivers, PDAs (Personal Digital Assistants), PMPs (Portable Multimedia Player), navigation devices, and the like.

It would be understood by a person in the art that the configuration according to the embodiments of this document can be also applicable to the fixed types of terminals such as digital TVs, desk top computers, or the like, except for any elements especially configured for a mobile purpose.

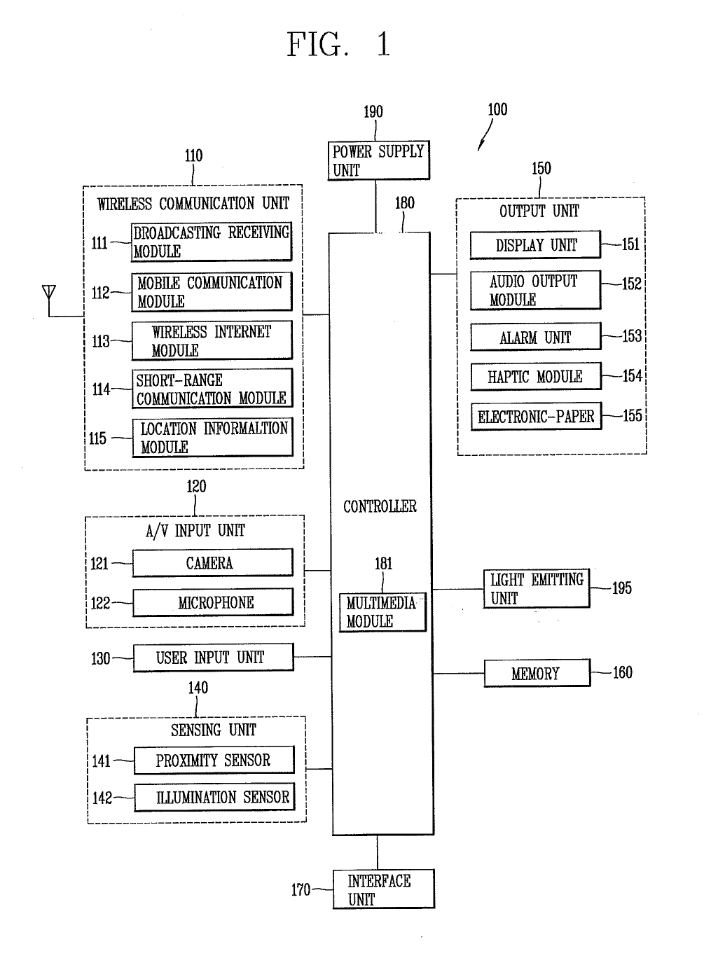

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System).

With reference to FIG. 1, the A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate input data from commands entered by a user to control various operations of the mobile terminal. The user input unit 130 may include a keypad, a dome switch, a touch pad (e.g., a touch sensitive member that detects changes in resistance, pressure, capacitance, etc. due to being contacted) a jog wheel, a jog switch, and the like.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, a haptic module, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. The display unit 151 may be a light emission display unit in that it uses a self-light emitting element. This is differentiated from an electronic-paper 155 (to be described).

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units (or other display means) according to its particular desired embodiment. For example, a plurality of display units may be separately or integrally disposed on one surface of the mobile terminal, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or other sound generating device.

The alarm unit 153 (or other type of user notification means) may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations (or other tactile or sensible outputs). When a call, a message, or some other incoming communication is received, the alarm unit 153 may provide tactile outputs (i.e., vibrations) to inform the user thereof. The display unit 151 and the audio output module 152 may be classified as a part of the alarm unit 153.

A haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

An electronic-paper 155 is a display device configured by applying the general characteristics of ink to paper, which is also called an e-paper. Unlike the conventional flat panel display using a backlight to illuminated pixels, the e-paper uses a reflected light like general paper. Thus, once letters or a picture displayed on the e-paper are changed, the letters and picture can be displayed without further power consumption. Also, the e-paper may be folded or bent, unlike a flat panel display. However, because the e-paper 155 does not include a backlight, the mobile terminal 100 may have a light emitting unit or may use a light emission function of the display unit 151 just in case it is difficult for the user to read the letters or a picture displayed on the e-paper 155 due to a low intensity of illumination outside the mobile terminal 100. The e-paper will be described in detail later.

The memory 160 may store software programs used for the processing and controlling operations performed by the controller 180, or may temporarily store data (e.g., a phonebook, messages, still images, video, etc.) that are inputted or outputted. The memory 160 may store the frequency of use of each data (e.g., the frequency of use of respective phone numbers, respective messages, and respective multimedia). In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

A light emitting unit 195 is disposed at one side of the e-paper and emits light automatically when certain data is displayed on the e-paper 155. A light emitting diode (LED) may be used as the light emitting unit 195. Meanwhile, when data is displayed on the e-paper 155 while the intensity of illumination lower than a certain value is measured from the illumination sensor, the light emitting unit 195 may be turned on. Also, instead of using the light emitting unit 195, a light emission function of the display unit 151 may be used. The use of the light emission function of the display unit 151 will be described in detail later.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, the controller 180 itself may implement such embodiments.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

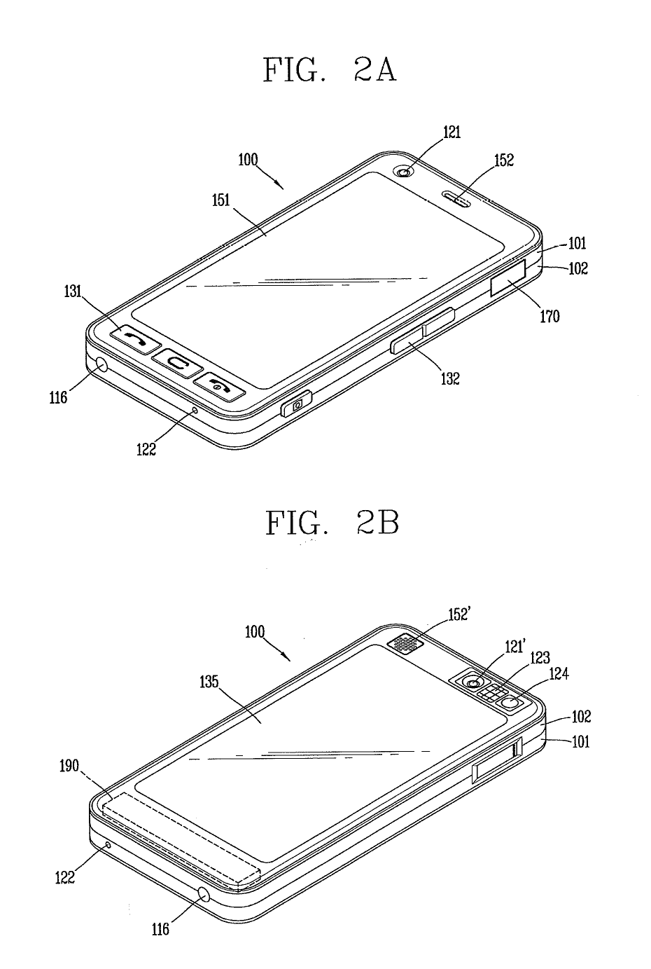

FIG. 2A is a front perspective view of a mobile terminal implementing an embodiment of the present invention;

The disclosed mobile terminal 100 has a bar type terminal body. However, without being limited thereto, the present invention can be also applicable to a slide type mobile terminal, a folder type mobile terminal, a swing type mobile terminal, a swivel type mobile terminal and the like, including two or more bodies.

The terminal body includes a case (or casing, housing, cover, etc.) constituting the external appearance of the terminal body. In the present exemplary embodiment, the case may be divided into a front case 101 and a rear case 102. Various electronic components are installed in the space between the front case 101 and the rear case 102. One or more intermediate cases may be additionally disposed between the front case 101 and the rear case 102.

The cases may be formed by injection-molding a synthetic resin or may be made of a metallic material such as stainless steel (STS) or titanium (Ti), etc.

The display unit 151, the audio output module 152, the camera 121, the user input units 130 (131, 132), the microphone 122, the interface 170, and the like, may be located on the terminal body, namely, mainly, on the front case 101.

The display unit 151 occupies the most portion of the front surface of the front case 101. The audio output unit 151 and the camera 121 are disposed at a region adjacent to one of both end portions of the display unit 151, and the user input unit 131 and the microphone 122 are disposed at a region adjacent to another of the both end portions. The user input unit 132, the interface 170, and the like, may be disposed at the sides of the front case 101 and the rear case 102.

The user input unit 130 is manipulated to receive commands for controlling the operation of the mobile terminal 100, and may include a plurality of manipulation units 131 and 132. The manipulation units 131 and 132 may be generally called a manipulating portion, and they can employ any method so long as they can be manipulated in a tactile manner by the user.

Content inputted by the first and second manipulation units 131 and 132 may be variably set. For example, the first manipulation unit 131 receives commands such as start, end, scroll, or the like, and the second manipulation unit 132 may receive commands such as adjustment of size of a sound outputted from the audio output unit 152 or conversion to a touch recognition mode of the display unit 151.

FIG. 2B is a rear perspective view of the mobile terminal illustrated in FIG. 2A according to an exemplary embodiment of the present invention.

With reference to FIG. 2B, a camera 121′ may additionally be disposed on a rear surface of the terminal body, namely, on the rear case 102. The camera 121′ may have an image capture direction which is substantially opposite to that of the camera 121 (See FIG. 2A), and may support a different number of pixels (i.e., have a different resolution) than the camera 121.

For example, camera 121 may operate with a relatively lower resolution to capture an image(s) of the user's face and immediately transmit such image(s) to another party in real-time during video call communication or the like. Meanwhile the camera 121′ may operate with a relatively higher resolution to capture images of general objects with high picture quality, which may not require immediately transmission in real time. The cameras 121 and 121′ may be installed on the terminal such that they are rotated or popped up.

A flash 123 and a mirror 124, may be additionally disposed adjacent to the camera 121′. When an image of the subject is captured with the camera 121′, the flash 123 illuminates the subject. The mirror 124 allows the user to see himself when he wants to capture his own image (i.e., self-image capturing) by using the camera 121′.

An audio output unit 152′ may be additionally disposed on the rear surface of the terminal body. The audio output unit 152′ may implement a stereoscopic function along with the audio output unit 152 (See FIG. 2A), and may be used for implementing a speaker phone mode during call communication.

A broadcast signal receiving antenna 116 may be disposed at the side of the terminal body in addition to an antenna that supports mobile communications. The antenna 116 forming a portion of the broadcast reception module 111 (in FIG. 1) may be installed to be protracted.

A power supply unit 190 for supplying power to the mobile terminal 100 may be mounted on the terminal body in order to supply power to the mobile terminal 100. The power supply unit 190 may be installed in the terminal body or may be directly detached from the outside of the terminal body.

A touch pad 135 may be additionally mounted on the rear case 102 to detect a touch. The touch pad 135 may be configured to be light-transmissive like the display unit 151. In this case, when the display unit 151 is configured to output visual information from both sides, the visual information can be recognized also through the touch pad 135. The information outputted from both sides can be controlled by the touch pad 135. Alternatively, a display may be additionally mounted on the touch pad 135, so a touch screen may be disposed also on the rear case 102.

The touch pad 135 is operated in relation to the display unit 151 of the front case 101. The touch pad 135 may be disposed to be parallel to the rear side of the display unit 151. The touch pad 135 may have a size which is the same as or smaller than the display unit 151.

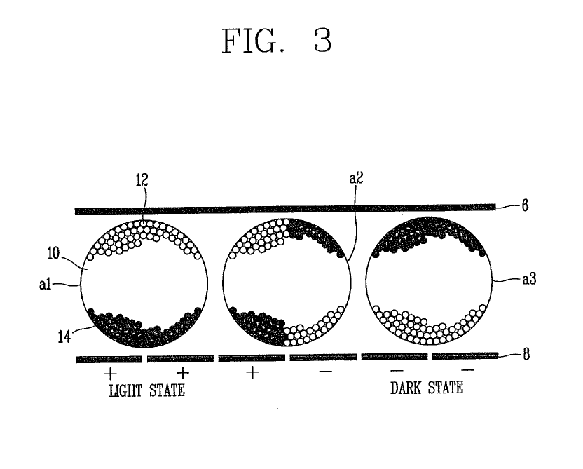

FIG. 3 is a view for explaining the principle of electronic-paper (or e-paper) 155 applied to an exemplary embodiment of the present invention. Specifically, FIG. 3 is sectional view of electronic ink micro-capsules a1, a2, and a3. As illustrated, the e-paper 155 includes a top transparent electrode 6, a bottom electrode 8, and electronic ink capsules 10. In the electronic ink capsule 10, positive charged white pigment chips 12 and negative charged black pigment chip 14 are disposed.

When the bottom electrode 8 is charged with the positive electrode, the white chip 12 moves to the top transparent electrode 6, so the electronic ink has a tinge of white, and when the bottom electrode 8 is charged with a negative electrode, the black chips 14 moves to the top transparent electrode 6, so the electronic ink has a tinge of black. The e-paper 155 including numerous electronic ink capsules 10 serves as a display unit. Also, the single electronic ink capsules 10 can simultaneously have the tinge of black and white. In this case, the bottom electrode 8 is charged with the negative electrode in one half of pixels and charged with the positive electrode in the other half of pixels.

Such e-paper 155 is a novel display device called an electronic ink. Also, the e-paper can implement a color video through a combination of a polymer coating technique and a chemical solution. An animation or a real movie of 30 frames per second can be displayed on the e-paper 155.

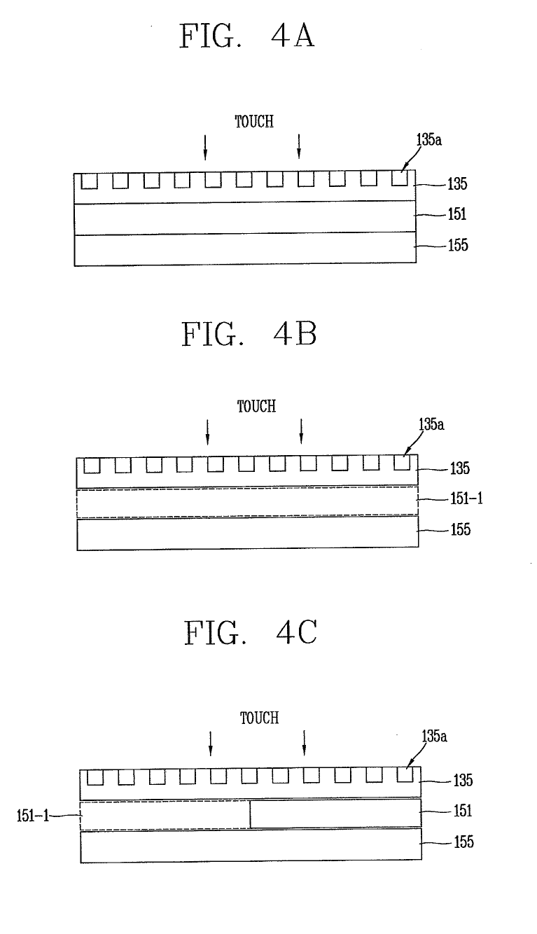

The associated operational method of the display unit 151, the touch pad 135, and the e-paper 155 will now be described with reference to FIG. 4A to FIG. 4C.

FIG. 4A to FIG. 4C are sectional views of a dual-display units for explaining the driving of the dual-display units with respect to a touch input in the mobile terminal having the dual-display units according to an exemplary embodiment of the present invention.

The dual-display units 151 and 155 may be configured as a display unit 151 using a transparent display (e.g., TOLED) and a display unit using the e-paper 155. Hereinafter, the display unit using the TOLED will be defined as a transparent display unit, and the display unit using the e-paper 155 will be defined as the e-paper 155. Various types of visual information can be displayed on the dual-display units. These types of information may be displayed in the form of characters, numbers, symbols, graphics, icons, or the like.

As shown in FIG. 4A to FIG. 4C, the structure of the dual-display units are configured such that the e-paper 155, the transparent display unit 151, and the touch pad 135 are sequentially stacked from the bottom in a layered manner.

With reference to FIG. 4A, when power is applied to the mobile terminal through the power supply unit 190, the controller 180 supplies power to both of the dual-display units or one of the dual-display units to display a main screen image on the e-paper 155 and/or the transparent display unit 151. When the controller 180 displays pre-set main screen images on the transparent display unit 151 and the e-paper 155, respectively, and the user executes a certain touch input to the transparent display unit 151 through an input device, the controller 180 recognizes that the touched area has been selected through the touch pad 135. The touch pad 135 includes the touch sensor 135a, so it can detect the user's touch input.

Thereafter, depending on a form (or a type) of the certain touch input, the controller 180 may determine if the touch input selects either the visual information displayed on the transparent display unit 151 or the visual information displayed on the e-paper 155, and also may determine if an application executed is to be displayed either on the transparent display unit 151 or on the e-paper 155.

With reference to FIG. 4B, when power is applied to the mobile terminal through the power supply unit 190, the controller 180 may set the transparent display unit 151 into a transparent operation mode 151-1 and display visual information (e.g., a main screen image) on the e-paper 155. The transparent operation mode of the transparent display unit 151 refers to a state in which the transparent display unit 151 is turned off or a state in which an electrical signal for displaying data is not applied to the pixels on the transparent display (e.g., the TOLED) when the transparent display unit 151 is turned on. Namely, as the power for displaying data on the transparent display unit 151 is not supplied, the transparent display unit 151 is in a transparent state where visual information such as a character, an image and the like is not displayed.

Thus, in the transparent operation mode, the visual information displayed on the e-paper 151, which is positioned under the transparent display unit 151, is externally displayed. In this state, if the user applies a certain touch input to the area of the visual information displayed on the e-paper 155, the controller 180 recognizes that the corresponding area has been selected through the touch pad 135.

In this case, the controller may determine that the transparent display unit 151 is currently set in the transparent operation mode and that the certain touch input is to select the visual information on the e-paper 155. Also, the controller 180 may determine if an application executed by the touch input is to be displayed either on the transparent display unit 151 or on the e-paper 155.

With reference to FIG. 4C, the controller 180 sets some pixels of the transparent display unit 151 into the transparent operation mode, and applies an electrical signal for displaying visual information to the other remaining pixels not set into the transparent operation mode to display certain data. Namely, the controller 180 may set a part of the transparent display unit separately into an operation mode (transparent operation mode or an active operation mode). The process of a touch input according to the operation mode is same as the case illustrated in FIGS. 4A and 4B, so its description will be omitted.

A control method that can be implemented in the mobile terminal configured as described above will now be described with reference to the accompanying drawings. The following exemplary embodiments may be used along or may be combined together so as to be used. Also, the following exemplary embodiments may be combined with the foregoing UI so as to be used.

The method for controlling display characteristics of the display unit 151 overlaid on the e-paper 155 will now be described.

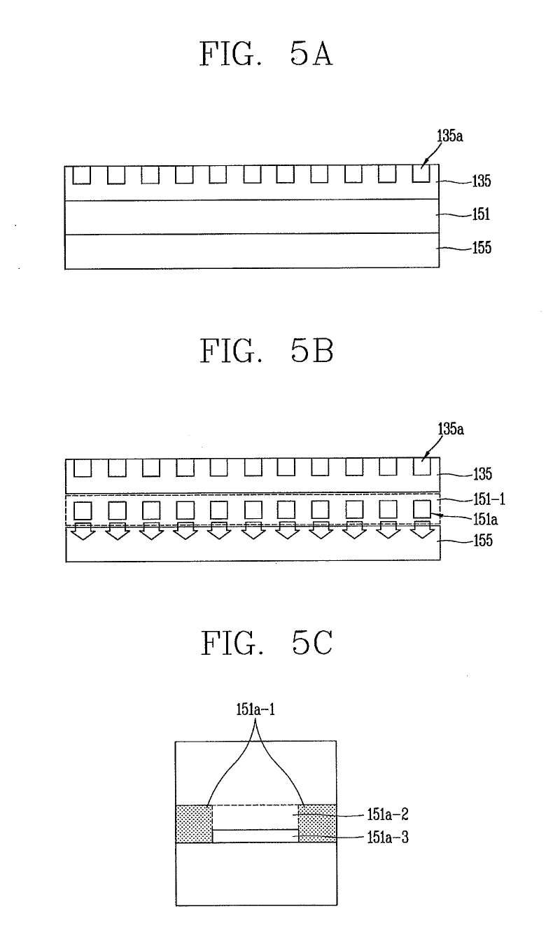

FIG. 5A and FIG. 5B are sectional views of the dual-display units illustrating the driving of the dual-display units controlling display characteristics in the mobile terminal having the dual-display units and FIG. 5C is a view of a exemplary structure of a light-emitting element. Like the case illustrated in FIG. 4, the structure of the dual-display units illustrated in FIG. 5A and FIG. 5B may be configured such that the e-paper 155, the transparent display unit 155, and the touch pad 135 are sequentially stacked from the bottom in a layered manner.

With reference to FIG. 5A, the controller does not provide an illumination function of the light emitting element included in the transparent display unit 151. Thus, when the transparent display unit 151 operates in the transparent mode, the user can read contents displayed on the e-paper 155 through the touch pad 135 and the transparent display unit 151. In this case, however, because the e-paper 155 does not have a self-illumination function, when the intensity of illumination outside the mobile terminal is not sufficient for the user to read the contents displayed on the e-paper 155, the controller 180 may need to operate the illumination function of the light emitting element included in the transparent display unit 151.

With reference to FIGS. 5B and 5C, the controller 180 may set the transparent display unit 151 into the transparent operation mode 151-1 and control display characteristics of the light emitting element 151a included in the transparent display unit 151. The display characteristics of the light emitting element 151a may be related to the transparency, the brightness, or the color of the light emitting element. For example, as shown in FIG. 5B, the controller 180 may control the display characteristics of the light emitting element 151a such that the intensity of illumination of light radiated to the e-paper 155 is increased of the color is changed, while maintaining the transparency. To this end, for example, as shown in FIG. 5C, the light emitting element 151a may have a structure in which a transparent getter 151a-2 and a metal cathode 151a-3 are coupled in an overlaid manner by using a transparent adhesive 151a-1. Thus, light radiated from the light emitting element 151a is reflected to the e-paper 155, and the transparent display unit 151 operates in the transparent mode 151-1, so the user can read contents displayed on the e-paper 155.

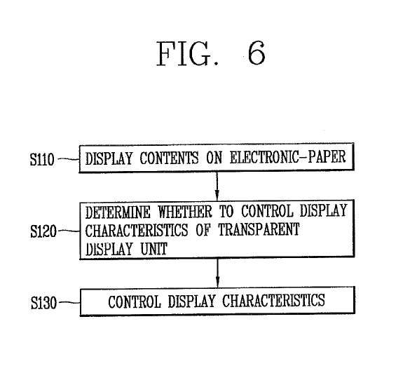

FIG. 6 is a flow chart illustrating the process of a method for controlling a mobile terminal including a display unit configured to include a light-transmissive light emitting element according to a first exemplary embodiment of the present invention. The first exemplary embodiment of the present invention relates to a basic method for controlling the display characteristics of the entire display unit or a portion of the display unit.

As shown In FIG. 6, first, the controller 180 displays contents on the e-paper 155 by executing an application (step S110). The contents displayed on the e-paper 155 may include a character, an image, or the like.

As described above, because the e-paper 155 does not have a self-light emitting element, the user can read a letter or a picture displayed on the e-paper 155 by using reflected light as in the case of reading a letter or a picture written on general paper. However, the controller may need to determine whether or not to control the display characteristics of the display unit 151 for the letter or the picture displayed on the e-paper 155 when the external illumination of the mobile terminal 100 is low (step S120).

Determining whether to change the display characteristics may be performed according to a user input received through an input device of the mobile terminal, by using time information in consideration of a sunset time or the like, or by using external illumination information of the mobile terminal acquired through the sensor or the like attached to the mobile terminal.

Next, the controller controls the display characteristics of the entirety or a portion of the display unit 151 (step S130). The controlling of the display characteristics may be performed by changing the display characteristics of the light emitting element included in the entire or a portion of the display unit 151. The display characteristics of the light emitting element may be related to the transparency, the brightness, or the color of the light emitting element. As described above, the controller may control the display characteristics of the light emitting element 151a such that the illumination of light radiated to the e-paper 155 is increased or the color is changed, while maintaining the transparency.

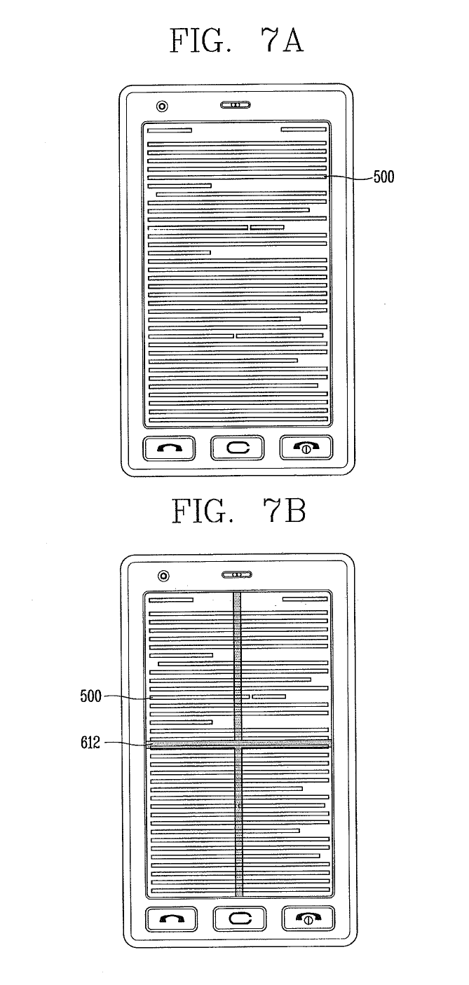

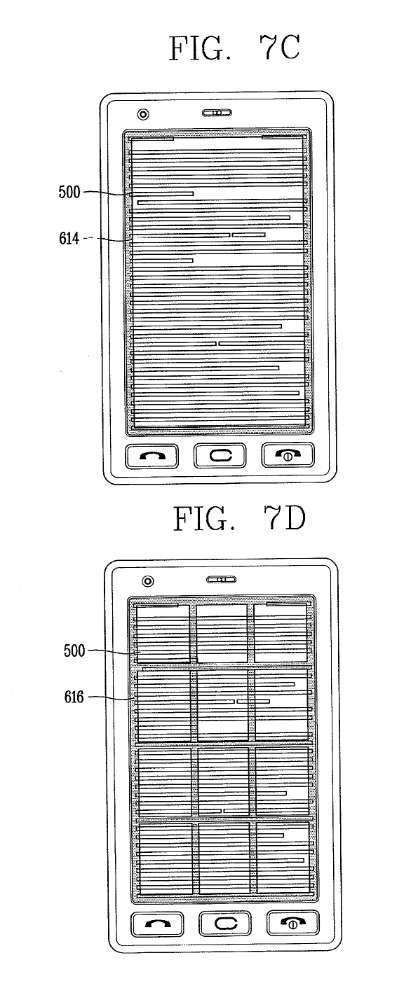

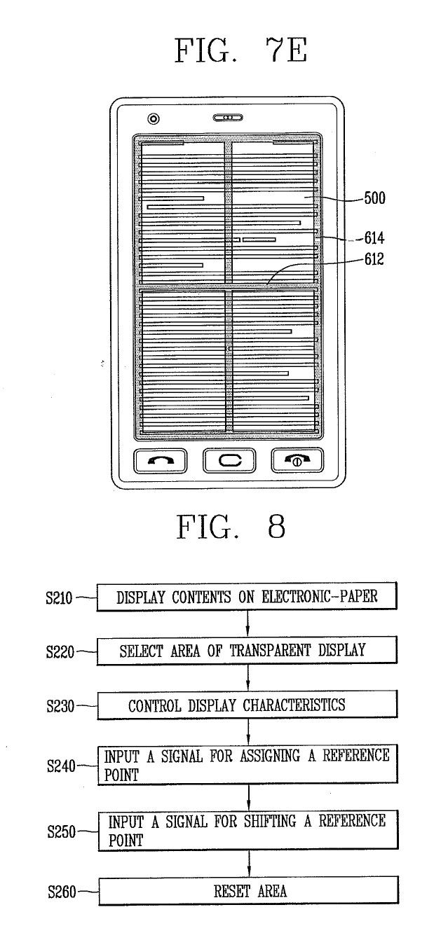

FIG. 7A to FIG. 7E illustrate application examples of a method for controlling the display characteristics of a particular area of the display unit configured to include the light-transmissive light emitting element according to a first exemplary embodiment of the present invention.

As shown in FIG. 7A, the controller 180 executes an application to display a certain image 500 (for example, an e-book reader screen image) on the e-paper 155. As described above, because the e-paper 155 does not have a self-light emitting element, the user can read a letter or a picture displayed on the e-paper 155 by using reflected light as in the case of reading a letter or a picture written on general paper. Thus, the mobile terminal 100 may use the light emission function of the display unit 151 for the letter or the picture displayed on the e-paper 155 when the external illumination is low.

In order to determine whether to use the light emission function of the display unit 151, the controller 180 may use a user input (e.g., a selection through a set menu, a selection through a button, and the like), time information (e.g., an automatic selection after a particular time), or external illumination information outside the mobile terminal (e.g., an automatic selection when illumination through an illumination sensor is less than a particular value).

As shown in FIGS. 7B to 7E, the controller 180 determines to use the light emission function of the display unit 151 and controls the display characteristics such as the brightness, or the like, of the light emitting element included in a particular area of the display unit 151. The particular area of the display unit 151 may be the entirety or a portion of the display unit 151, and the size and/or position of the particular area may be determined in consideration of readability of the letter or the like displayed on the e-paper 155, determined according to a pre-set mode, determined on the basis of the external illumination information of the mobile terminal, or determined according to a user input.

For example, when reflected light required for reading the letter or the like displayed on the e-paper 155 is provided by a certain degree from the exterior of the mobile terminal, the controller 180 may control the display characteristics of the relatively narrow areas such as a portion 612 vertically and horizontally traversing a screen 500 on the display unit 151 as shown in FIG. 7B, an edge portion 614 of the screen 500 on the display unit 151 as shown in FIG. 7C, or the like. Similarly, when light of a stronger intensity of illumination is required to read the letter or the like displayed on the e-paper 155, the controller 180 may control the display characteristics of the relatively larger area 616 of the display unit 151 as shown in FIG. 7D or control the display characteristics of the area obtained by adding the relatively small areas as shown in FIG. 7E, namely, the area obtained by adding the areas 612 and 614 controlled in the FIGS. 7B and 7C.

The controlling of the display characteristics of the particular area of the display unit 151 may be related to the transparency, the brightness, the color, and the like, of the light emitting elements within the particular area. As for the controlling method related to the transparency, the controller 180 may control the display characteristics of the display unit 151 to maintain the transparency by changing a state from OFF to ON and refraining from applying an electrical signal for displaying data to the light emitting elements within the area. Also, if the display unit 151 is in the ON state, the controller 180 may control the display unit 151 to maintain the transparency by refraining from applying an electrical signal for displaying data to the light emitting elements within the area while keeping the ON state of the display unit 151. As for the controlling method related to the brightness, the controller 180 may control the display characteristics of the display unit 151 to change the intensity of illumination of the light emitting elements within the area to be stronger. As for the controlling method related to the color, the controller 180 may control the display unit 151 to adjust the color of light radiating from the light emitting elements within the area such that the letter or the like displayed on the e-paper 155 can be easily read.

FIG. 8 is a flow chart illustrating the process of a method for controlling a mobile terminal including a display unit configured to include a light-transmissive light emitting element according to a second exemplary embodiment of the present invention. Compared with the first exemplary embodiment of the present invention as described above, in the second exemplary embodiment of the present invention, the controller selects an area of the display unit whose display characteristics are to be controlled according to a user input, and also shifts the selected area according to a user input.

As shown in FIG. 8, first, the controller executes an application to display contents on the e-paper 155 (step S210). Next, the controller receives an input signal of the user inputted to the touch pad 135 integrated with the display unit and selects a particular area of the display unit according to the input signal (step S220). The particular area of the display unit may be determined by setting the boundary of the particular area on the display unit and selecting the interior of the boundary. In setting the boundary of the particular area, the boundary line is demarcated along a closed loop, starting from a portion of the first display unit to which a touch input is provided as a start point, the contour of the boundary line being determined along a path to which a drag input is provided, and ending at the point when the touch point is stopped at the start point or at a portion near the start point.

And then, the controller controls the display characteristics of the selected area (step S230). Step S230 is the same as step S130 in FIG. 6, so a detailed description thereof will be omitted.

Thereafter, the controller may shift the selected area based on a user input. This relates to the case that when the user wants to read contents displayed on a different portion of the e-paper 155 rather than the selected area, the controller selects the different area having the same boundary shape as the already selected area and controls the display characteristics of the different area.

To this end, the controller receives a signal for assigning a reference point through the touch pad 135 of the mobile terminal (step S240). For example, the controller may recognize a certain point to which a touch input signal is inputted within the selected area of the display unit and assign a point corresponding to the certain point, as a reference point.

And then, the controller may receive an input signal for shifting the assigned reference point (step S250). For example, when a drag signal is inputted after the input signal for assigning the reference point, the controller may shift the position of the reference point along a path along which the drag input is provided. For another example, in shifting the reference point, the controller may use a motion signal acquired according to a motion recognition function on the basis of an image with respect to a face motion or an eye motion inputted from the camera 121 of the mobile terminal.

Next, the controller resets the boundary of the area on the display unit on the basis of the position of the shifted reference point (step S260). In this case, the reset boundary has the same shape as the boundary of the selected area before the reference point was shifted, and a relative position of the shifted reference point within the reset boundary may be the same as the selected area before the shifting of the reference point and the relative position of the position of the reference point before shifting of the reference point.

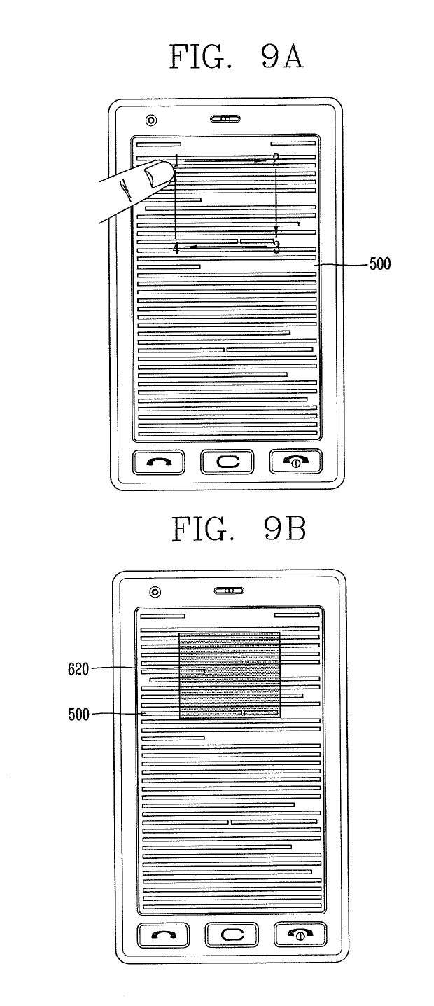

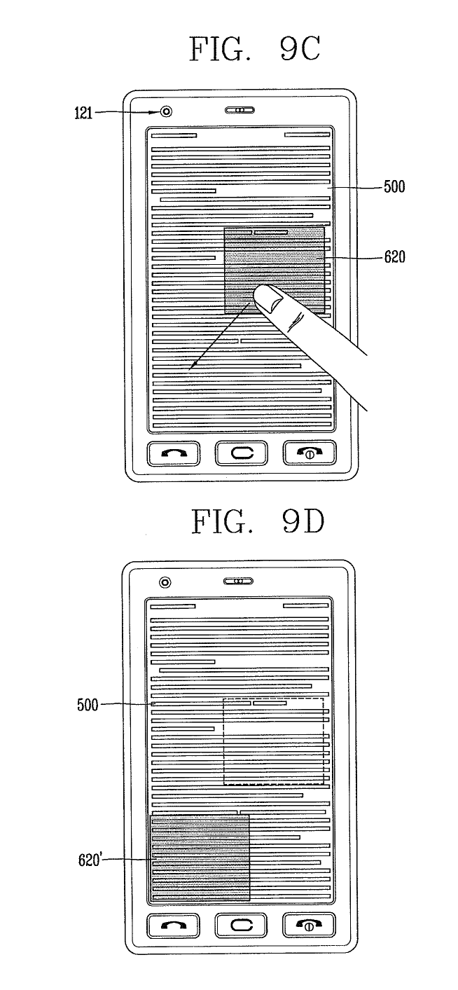

FIG. 9A to FIG. 9D illustrate application examples of a method for controlling the display characteristics of a particular area of the display unit configured to include the light-transmissive light emitting element according to the second exemplary embodiment of the present invention.

Compared with the case illustrated in FIGS. 7B to 7E, in FIGS. 9A and 9B, the user provides an input signal to the touch pad 135 integrated with the display unit 151 through an input device (e.g., a user's finger) to select a particular area of the display unit 151, and shift the selected particular area.

For example, when the user executes a touch input to a certain point on the display unit 151, the controller 180 recognizes the portion to which the touch input is provided through the touch pad 135 as a start point. Thereafter, when the user provides a drag input, the controller 180 recognizes a path along which the drag input is provided as a contour, and when the drag input or the touch input is stopped at the start point or near the start point, the controller 180 recognizes the start point as an end point. Thus, the controller 180 sets the boundary demarcated along a closed loop formed by the recognized start point, the contour, and the end point, and controls display characteristics of a particular area 620 on the display unit which corresponds to the interior of the boundary. A detailed method for controlling the display characteristics with respect to the particular area is the same as the first exemplary embodiment as described above, so its detailed description will be omitted.

With reference to FIGS. 9C and 9D, the user may provide an input signal to the touch pad 135 integrated with the display unit 151 through an input device (e.g., the user's finger) in order to shift the selected particular area 620 to a different area 620′.

For example, when the user inputs a touch signal in the selected area 260 on the display unit through the touch pad 135, the controller may recognize the portion to which the touch input has been provided, and assign it as a reference point of an area shifting. Thereafter, when the user provides a drag input by a signal indicating a reference point shifting path, the controller may shift the position of the reference point along the path along which the drag input is provided.

In another example, the controller may use a motion signal by a motion recognition function as the signal indicating the reference point shifting path, which is based on an image of a face motion or an eye motion acquired from the camera 121 of the mobile terminal. Thereafter, when the input of the signal indicating the reference point shifting path is stopped, the controller may reset the boundary of an area on the display unit on the basis of the position of the newly shifted reference point and determine the different area 620′ as a selected area. A detailed method for controlling the display characteristics with respect to the different selected area 620′ is the same as the method of controlling the former selected area 620 as described above, so its detailed description will be omitted.

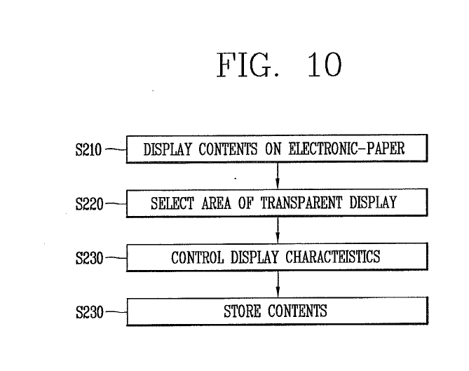

FIG. 10 is a flow chart illustrating the process of a method for controlling a mobile terminal including a display unit configured to include a light-transmissive light emitting element according to a third exemplary embodiment of the present invention. In the third exemplary embodiment of the present invention, an area on the display unit corresponding to a contents displayed portion displayed on the e-paper is selected and display characteristics of the selected area are controlled. Namely, compared with the second exemplary embodiment, in the third exemplary embodiment of the present invention, an input for selecting a particular area on the display unit is received, and the particular area is determined considering the portion where the contents is displayed on the e-paper. Since the controller controls the display characteristics of the area on the display unit corresponding to the portion related to the contents, the contents on the e-paper may be seen to be highlighted or underlined.

As shown in FIG. 10, first, the controller executes an application to display contents on the e-paper 155 (step S310). Next, the controller receives a user input signal though the touch pad 135 integrated with the display unit, and selects a particular area of the display unit in consideration of the input signal and the contents displayed portion on the e-paper (step S320).

Namely, in the third exemplary embodiment of the present invention, since the portion corresponding to highlight or underline on the display unit will be selected, the particular area may be the portion where the particular contents is displayed or the vicinity of the particular contents on the e-paper.

For example, the particular area is the interior of the boundary of the portion on the e-paper where the particular contents is displayed or a portion including the vicinity of the particular contents, and the particular contents used for the determination of the boundary may be contents included within the selected area by a user input. In other words, the selected area including the particular contents may be an area included in the interior of a closed loop formed, starting from a portion of the first display unit to which a touch input is provided as a start point, the contour of the boundary line being determined along a path to which a drag input is provided, and ending at the start point when the touch point is stopped at the start point or at a portion near the start point, as an end point.

For another example, the particular area may correspond to an underline of the particular contents, and the particular contents used for the determination of the under line may be contents displayed on the e-paper corresponding to a line formed, starting from a portion of the first display unit to which a touch input is provided as a start point, the line path of the boundary line being determined along a path to which a drag input is provided, and ending at a point at which the touch point is stopped as an end point.

Thereafter, the controller controls the display characteristics of the selected area (step S330). Step S330 is the same as step S130 in FIG. 6, so its detailed description will be omitted.

Thereafter, the controller stores the particular contents in a repository (step S340). Step S340 may be performed according to a user input or may be automatically performed after the particular area is selected. The repository may be a memory of the mobile terminal. The stored particular contents may be used in the way that the particular contents is provided later without a user input by being extracted from the repository. Thus, according to the third exemplary embodiment of the present invention, the user may perform a copy and paste of the contents corresponding to the particular area.

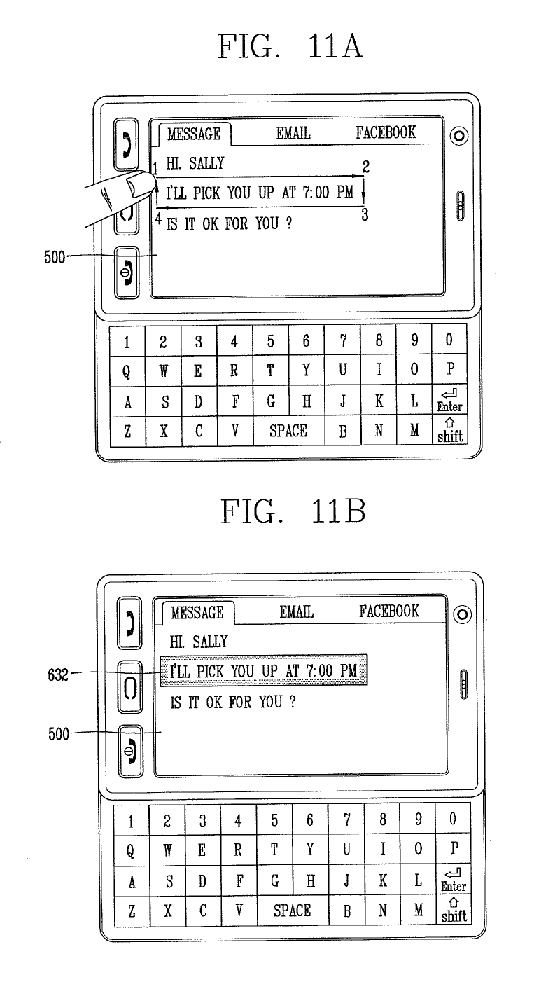

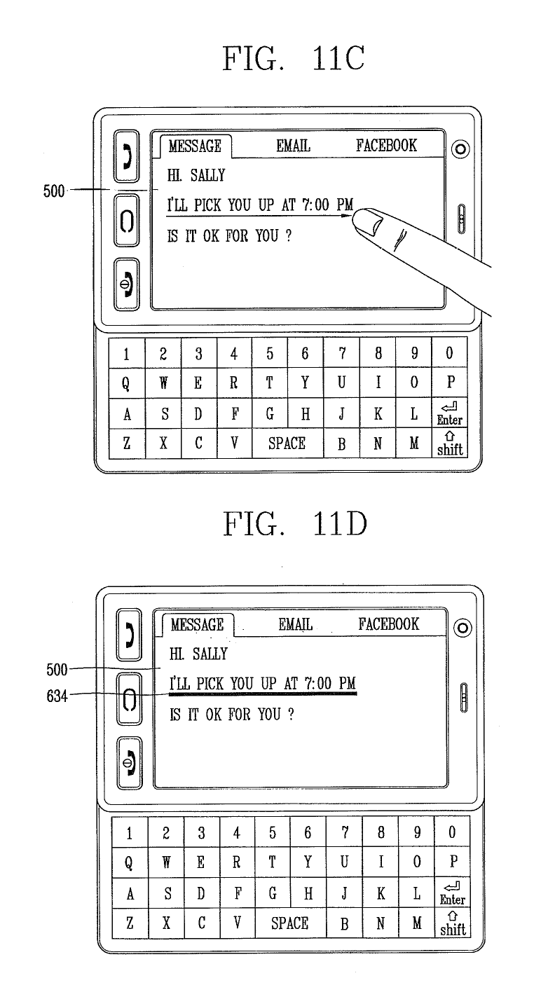

FIG. 11A to FIG. 11D illustrate application examples of a method for controlling the display characteristics of a particular area of the display unit configured to include the light-transmissive light emitting element according to the third exemplary embodiment of the present invention.

In the third exemplary embodiment of the present invention illustrated in FIG. 11A to FIG. 11D, compared with the case illustrated in FIGS. 7 to 9, when the user provides an input for selecting a particular area of the display unit 151 to the touch pad 135 integrated with the display unit 151 through an input device (e.g., a user's finger) the particular area is determined in consideration of contents to be displayed on the e-paper 155 corresponding to the inputted area.

For example, with reference to FIGS. 11A and 11B, when the user performs a touch input to a certain point on the display unit 151, the controller 180 recognizes the portion to which the touch input is provided through the touch pad 135 as a start point. Thereafter, when the user provides a drag input, the controller 180 recognizes a path along which the drag input is provided as a contour, and when the drag input or the touch input is stopped at the start point or near the start point, the controller 180 recognizes the start point as an end point. Thus, the controller 180 sets the boundary (e.g., indicated by 1 to 4) demarcated along a closed loop formed by the recognized start point, the contour, and the end point, and determines the particular area on the display unit considering the portion where the contents on the e-paper (e.g., “I'LL PICK YOU UP AT 7:00 PM”) is displayed. The contents used for determination of the particular area is related to the portion corresponding to the interior of the boundary. Namely, for example, the portion where the contents is displayed may be an assigned area for displaying one of a row in which the contents is positioned, words including the contents, and a sentence including the contents. For example, in FIG. 11B, the portion where the contents is displayed corresponds to the portion occupied by the row in which the contents is positioned, and the controller 180 determines a particular area 632 on the display unit corresponding to the entirety of the contents displayed portion, as an area for controlling display characteristics.

For another example, with reference to FIGS. 11C and 11D, the particular area may be a portion corresponding to an underline of the particular contents. When the user performs a touch input to a certain point on the display unit 151, the controller 180 recognizes the portion to which the touch input is provided through the touch pad 135 as a start point, recognizes a path to which a drag input is provided as a line path, and recognizes a portion at which the touch input or the drag input is stopped as an end point. Thus, the controller 180 determines a particular area on the display unit in consideration of the portion where the contents is displayed on the e-paper, and the content displayed portion overlaps with the line formed by the start point, the line path, and the end point that are recognized as described above. Namely, likewise as the cases of FIGS. 11A and 11B, the portion where the contents is displayed may be an assigned area for displaying one of a row in which the contents is positioned, words including the contents, and a sentence including the contents. For example, in FIG. 11D, the portion where the contents is displayed corresponds to the portion occupied by the row in which the contents is positioned, and the controller 180 determines a particular area 634 on the display unit corresponding to the lower portion, namely, the underlined portion, of the contents displayed portion, as an area for controlling display characteristics.

Besides, the particular area on the display unit may be determined in consideration of various expression methods that can be considered to display the contents on the e-paper. A detailed method for controlling the display characteristics with respect to the particular area is the same as the first exemplary embodiment as described above, so its detailed description will be omitted.

The controller 180 may store the particular contents referred to in order to determine the particular area in a repository. Storing of the particular contents may be performed according to a user input or may be automatically performed after the particular area is selected. The stored particular contents may be used in the way that the particular contents is provided later without a user input by being extracted from the repository. Thus, the user may perform a copy and paste of the contents corresponding to the particular area.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A method for controlling a mobile terminal including a first display unit and a second display unit, the first display unit including light-transmissive light emitting elements, the second display unit overlaid on the first display unit, the method comprising:
displaying contents on the second display unit; and
controlling display characteristics of a specific area of the first display unit by changing a display characteristic of a light emitting element included in the specific area.

2. The method of claim 1, wherein the specific area is an entire area of the first display unit or a sub-area of the first display unit.

3. The method of claim 1, wherein the display characteristic of the light emitting element included in the specific area is a characteristic related to transparency, brightness, or color of the light emitting element included in the specific area.

4. The method of claim 3, wherein the step of changing a display characteristic of the light emitting element included in the specific area comprises:
maintaining transparency of the specific area while changing one of an intensity and a color of light emitted by the light emitting element.

5. The method of claim 1, further comprising:
determining whether or not to control the display characteristic of the light emitting element included in the specific area based on one of a preset criteria and a user input.

6. The method of claim 5, wherein the preset criteria is one of time information and information about an illumination condition outside of the mobile terminal.

7. The method of claim 1,
wherein the mobile terminal comprises a touch sensor located in the specific area of the first display unit, and
wherein the step of changing a display characteristic of the light emitting element included in the specific area comprises:
selecting the specific area based on a signal from the touch sensor generated in response to a user touch to the specific area.

8. The method of claim 7, wherein the step of selecting the specific area comprises setting a boundary line of the specific area and selecting an interior of the specific area.

9. The method of claim 8, wherein the step of setting the boundary line comprises:
setting the boundary line as a closed loop based on at least a partially closed-loop drag of the user touch.

10. The method of claim 9, further comprising:
moving the closed loop in response to a move command.

11. The method of claim 10, wherein the move command corresponds to a drag of the closed loop.

12. The method of claim 10,
wherein the mobile terminal further comprises a camera having a motion recognition function, and
wherein the move command comprises a signal corresponding to a motion of a face and/or a motion of an eye detected by the camera.

13. A method for controlling a mobile terminal including a first display unit and a second display unit, the first display unit including a touch sensor and light-transmissive light emitting elements, the second display unit overlaid on the first display unit, the method comprising:
displaying contents on the second display unit;
selecting a specific area of the first display unit based on a signal from the touch sensor generated in response to a user touch to the specific area; and
controlling display characteristics of the specific area of the first display unit by changing a display characteristic of a light emitting element included in the specific area.

14. The method of claim 13, wherein the display characteristic of the light emitting element included in the specific area is a characteristic related to transparency, brightness, or color of the light emitting element included in the specific area.

15. The method of claim 13, further comprising:
storing the contents in a repository of the mobile terminal.

16. The method of claim 13, wherein the step of selecting the specific area comprises setting a boundary line of the specific area as a closed loop based on at least a partially closed-loop drag of the user touch and selecting an interior of the specific area.

17. The method of claim 16, wherein step of setting the boundary line of the specific area as the closed loop comprises:
setting the closed loop around a subset of displayed text or around a displayed image.

18. A mobile terminal, comprising:
a first display unit including light-transmissive light emitting elements;
a second display unit overlaid on the first display unit; and
a controller operatively connected to the first and second display units, the controller configured to display contents on the second display unit and control display characteristics of a specific area of the first display unit by changing a display characteristic of a light emitting element included in the specific area,
wherein the specific area is one of an entire area of the first display unit and a sub area of the first display unit,
wherein the display characteristic of the light emitting element included in the specific area is a characteristic related to transparency, brightness, or color of the light emitting element included in the specific area, and
wherein the controller is configured to maintain transparency of the specific area while changing one of an intensity and a color of light emitted by the light emitting element.

19. A mobile terminal, comprising:
a first display unit including light-transmissive light emitting elements;
a second display unit overlaid on the first display unit;
a repository;
a touch sensor integrated with the first display unit; and
a controller operatively connected to the first display unit, the second display unit, the repository and the touch sensor, the controller configured to
display contents on the second display unit,
select a specific area of the first display unit based on a signal from the touch sensor generated in response to a user touch to the specific area,
control display characteristics of the selected specific area by changing display characteristics of a light emitting element included in the selected specific area, and
store the contents in the repository.
